(19) United States
(12) Patent Application Publication
(10) Pub. No.: US 2025/0091481 A1
(43) Pub. Date: Mar. 20, 2025

(54) MOBILITY APPARATUS AND A METHOD FOR CONTROLLING DRIVING CURRENT FOR THE SAME

(71) Applicants: HYUNDAI MOTOR COMPANY, Seoul (KR); KIA CORPORATION, Seoul (KR)

(72) Inventors: Sang Hyuk KIM, Hwaseong-si (KR); Dae Won YANG, Hwaseong-si (KR)

(21) Appl. No.: 18/826,697

(22) Filed: Sep. 6, 2024

(30) Foreign Application Priority Data
Sep. 18, 2023 (KR) 10-2023-0123998

(51) Int. Cl. B60L 58/22; B60L 53/80; B60L 58/13; B60L 58/16

(52) U.S. Cl. CPC B60L 58/22; B60L 53/80; B60L 58/13; B60L 58/16

(57) ABSTRACT

A mobility apparatus and a method for controlling driving current for the mobility apparatus. The mobility apparatus includes a plurality of first wheels, at least one first driving motor configured to supply a driving force to the plurality of first wheels, a first high voltage battery configured to supply power to the at least one first driving motor, and a first controller configured to control the at least one first driving motor and the first high voltage battery. With a second high voltage battery detachably connected to supply power to the at least one first driving motor through a DC/DC converter, the first controller determines a driver's required torque and respective distributed currents of the first high voltage battery and the second high voltage battery according to their respective efficiency-related states in accordance with the driver's required torque.

### CROSS-REFERENCE TO RELATED APPLICATIONS

The present application claims priority to Korean Patent Application No. 10-2023-0123998, filed on Sep. 18, 2023, the entire contents of which are incorporated herein for all purposes by this reference.

### TECHNICAL FIELD

The present disclosure relates to a mobility apparatus and a method of controlling driving current for the mobility apparatus.

### BACKGROUND

The statements in this section merely provide background information related to the present disclosure and may not constitute prior art.

Generally, an electric vehicle is driven with its wheels driven by a driving force of a driving motor.

In addition, it is common for a high voltage battery to be fixed to and mounted on the vehicle to supply power to the driving motor.

The driving motor may be an AC motor, so an inverter may be arranged between the battery and the driving motor.

When the battery of an electric vehicle requires charging according to its state of charge (SOC), it is charged by receiving external power through an on-board charger (OBC).

The time required for charging an electric vehicle is determined depending on the charging method, and there are two main types of charging: slow charging and fast charging.

By virtue of continuous research and development on batteries, in recent days, driving range per charge has been significantly improved.

However, the battery fixed to and mounted on the battery of an electric vehicle may still be insufficient, so an alternative is needed.

The information included in this Background of the present disclosure section is only for enhancement of understanding of the general background of the present disclosure and may not be taken as an acknowledgement or any form of suggestion that this information forms the prior art already known to a person skilled in the art.

### SUMMARY

The present disclosure aims to alleviate or solve the above-described conventional problems.

The present disclosure aims to propose a new concept of using a second high voltage battery that can be attached to and detached from the power system of an electric vehicle as needed in addition to a first high voltage battery that has been already installed in the electric vehicle.

One implementation of the present disclosure aims to improve energy efficiency by distributing and controlling the driving current of an electric vehicle based on the efficiency-related states of the first high voltage battery and the second high voltage battery.

A mobility apparatus may include a plurality of first wheels, at least one first driving motor configured to supply driving force to the plurality of first wheels, a first high voltage battery configured to supply power to the at least one first driving motor, and a first controller configured to control the at least one first driving motor and the first high voltage battery, wherein, in a state where a second high voltage battery is detachably connected to supply power to the at least one first driving motor, the first controller is further configured to determine a driver's required torque, and determine respective distributed currents of the first high voltage battery and the second high voltage battery according to their respective efficiency-related states in accordance with the driver's required torque.

According to at least one implementation of the present disclosure, the controller is further configured to determine a distributed current of each of the first high voltage battery and the second high voltage battery for each of a plurality of cases for which distribution ratios have been predetermined, determine a first efficiency value for the first high voltage battery and a second efficiency value for the second high voltage battery for each of the plurality of cases, and determine one of the plurality of cases based on the first efficiency value and the second efficiency value for each of the plurality of cases.

According to at least one implementation of the present disclosure, the controller is further configured to determine an integrated efficiency value based on the first efficiency value and the second efficiency value for each of the plurality of cases, and determine a case of a greatest value in the integrated efficiency value among the plurality of cases.

According to at least one implementation of the present disclosure, the integrated efficiency value is determined based on a multiplication value of the first efficiency value, the second efficiency value, and a gain.

According to at least one implementation of the present disclosure, the second high voltage battery is detachably connected to the at least one first driving motor through a DC/DC converter, and the gain is determined based on a state of health (SoH) of the first high voltage battery, a capacity of the first high voltage battery, a capacity of the second high voltage battery, a path efficiency between the first driving motor and the second high voltage battery, and an efficiency of the DC/DC converter.

According to at least one implementation of the present disclosure, the first efficiency value is determined according to a first efficiency map for SoC, temperature, and electric current of the first high voltage battery, and the second efficiency value is determined according to a second efficiency map for SoC, temperature, and electric current of the second high voltage battery.

According to at least one implementation of the present disclosure, the mobility apparatus may further include a memory configured to store one or more efficiency maps based on a type of high voltage battery, wherein the first controller selects the second efficiency map from the one or more efficiency maps based on information on a type of the second high voltage battery.

According to at least one implementation of the present disclosure, in response that it is determined that the one or more efficiency maps do not include the second efficiency map corresponding to the information on the type of the second high voltage battery, the first controller may request download of the second efficiency map to an external server.

According to at least one implementation of the present disclosure, the first controller is further configured to determine a battery efficiency optimization mode based on a driver's selection.

According to at least one implementation of the present disclosure, the second high voltage battery is detachably connected to the at least one first driving motor through a DC/DC converter, and the first controller is further configured to transmit a control command to the DC/DC converter according to the distributed current of the second high voltage battery.

According to at least one implementation of the present disclosure, the first controller is further configured to limit a rate of change of the driver's required torque.

In some examples, according to one implementation of the present disclosure, there is provided a method of controlling driving current for a mobility apparatus including a plurality of first wheels, at least one first driving motor configured to supply a driving force to the plurality of first wheels, a first high voltage battery configured to supply power to the at least one first driving motor, and a first controller configured to control the at least one first driving motor and the first high voltage battery, wherein the method may include determining a driver's required torque in a state where a second high voltage battery is detachably connected to supply power to the at least one first driving motor, and determining respective distributed currents of the first high voltage battery and the second high voltage battery according to their respective efficiency-related states in accordance with the driver's required torque.

According to at least one implementation of the present disclosure, the determining of the respective distributed currents includes determining a distributed current of each of the first high voltage battery and the second high voltage battery for each of a plurality of cases for which distribution ratios have been predetermined, determining a first efficiency value for the first high voltage battery and a second efficiency value for the second high voltage battery for each of the plurality of cases, and determining one of the plurality of cases based on the first efficiency value and the second efficiency value for each of the plurality of cases.

According to at least one implementation of the present disclosure, the determining of one of the plurality of cases includes determining an integrated efficiency value based on the first efficiency value and the second efficiency value for each of the plurality of cases, and determining a case of a greatest value in the integrated efficiency value among the plurality of cases.

According to at least one implementation of the present disclosure, the integrated efficiency value is determined based on a multiplication value of the first efficiency value, the second efficiency value, and a gain.

In a method of at least one implementation of the present disclosure, the second high voltage battery is detachably connected to the at least one first driving motor through a DC/DC converter, and the gain may be determined based on the state of health (SoH) of the first high voltage battery, the capacity of the first high voltage battery, the capacity of the second high voltage battery, the path efficiency between the first driving motor and the second high voltage battery, and the efficiency of the DC/DC converter.

According to at least one implementation of the present disclosure, the first efficiency value is determined according to a first efficiency map for SoC, temperature, and electric current of the first high voltage battery, and the second efficiency value is determined according to a second efficiency map for SoC, temperature, and electric current of the second high voltage battery.

According to at least one implementation of the present disclosure, the mobility apparatus may further include a memory configured to store one or more efficiency maps based on a type of high voltage battery, and the controlling method further comprises selecting the second efficiency map from the one or more efficiency maps based on information on a type of the second high voltage battery.

The controlling method according to at least one implementation of the present disclosure may further include requesting, by the first controller, download of the second efficiency map to an external server in response that it is determined that the one or more efficiency maps do not include the second efficiency map corresponding to the information on the type of the second high voltage battery.

The controlling method according to at least one implementation of the present disclosure may further include determining a battery efficiency optimization mode based on a driver's selection.

According to one implementation of the present disclosure, it may be possible to obtain a mobility apparatus of a new concept of using the second high voltage battery that can be attached to and detached from a power system as needed in addition to the first high voltage battery that has been already installed.

According to one implementation of the present disclosure, it may be possible to improve energy efficiency of a mobility apparatus by distributing and controlling a driving current based on the efficiency-related states of the first high voltage battery and the second high voltage battery.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 shows an example of a power system of a first mobility apparatus.

FIG. 2 shows an example of the first mobility apparatus connected to a second mobility apparatus.

FIG. 3 shows an example of input/output information of a first controller.

FIG. 4 shows an example of an efficiency map for the SOC, the temperature, and the current of a high voltage battery.

FIG. 5 shows an example of a control process.

FIGS. 6A-6F illustrate an example of determining a case with an optimal efficiency.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes, will be determined in part by the particularly intended application and use environment.

In the figures, the same reference numerals refer to the same or equivalent parts of the present disclosure throughout the several figures of the drawing.

### DETAILED DESCRIPTION

Because various changes can be made to the present disclosure and a range of implementations can be made for the present disclosure, specific implementations will be illustrated and described in the drawings. However, this is not intended to limit the present disclosure to the specific implementations, and it should be understood that the present disclosure includes all changes, equivalents, and substitutes within the technology and the scope of the present disclosure.

In this application, a unit, a control unit, a control device, or a controller is only a term widely used to name devices for controlling a certain function, and may not mean a generic function unit. For example, devices with these names may include a communication device that communicates with other controllers or sensors to control a certain function, a computer-readable recording medium that stores an operating system, logic instructions, input/output information, etc., and one or more processors that perform operations of determination, calculation, making decisions, etc. required to control the function.

In some examples, the processor may include a semiconductor integrated circuit and/or electronic devices that carry out operations of at least one of comparison, determination, calculation, and making decisions to perform a programmed function. For example, the processor may be any one or a combination of a computer, a microprocessor, a CPU, an ASIC, and an electronic circuit such as circuitry and logic circuits.

Examples of the memory may include all types of storage devices for storing data that can be read by a computer system. For example, they may include at least one of a memory such as a flash memory, a hard disk, a micro memory, and a card memory, e.g., a secure digital card (SD card) or an eXtream digital card (XD card), and a memory such as a random access memory (RAM), a static ram (SRAM), a read-only memory (ROM), a programmable ROM (PROM), an electrically erasable PROM (EEPROM), a magnetic RAM (MRAM), a magnetic disk, and an optical disk.

Such a memory may be electrically connected to the processor, and the processor may load and write data from the memory. The memory and the processor may be integrated or may be physically separate.

Hereinafter, the implementations of the present disclosure will be described in detail with reference to the attached drawings.

Hereinafter, the accompanying drawings will be briefly described, and the implementations of the present disclosure will be described in detail with reference to the drawings.

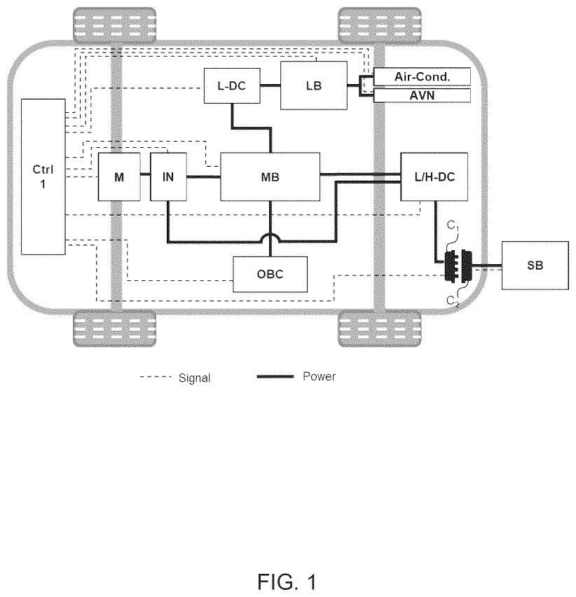

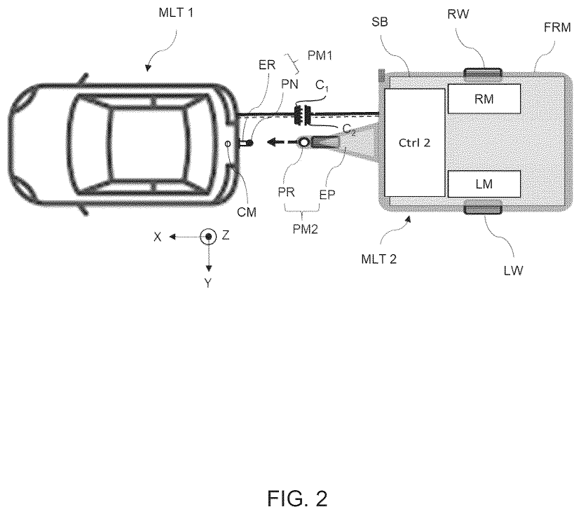

FIG. 1 conceptually shows the power system of a first mobility apparatus MLT 1, such as an electric vehicle, and FIG. 2 shows how a second mobility apparatus MLT 2 is connected to the first mobility apparatus MLT 1.

With reference to FIGS. 1 and 2, the structure of each of the first mobility apparatus MLT 1 and the second mobility apparatus MLT 2 will be described.

As shown in FIG. 1, in some implementations, the first mobility apparatus MLT 1 may be, for example, an electric vehicle, and may include a first driving motor M, an inverter IN, a first high voltage battery MB, an on-board charger OBC, a first DC/DC converter L-DC, a low voltage battery LB, a low voltage air-conditioning device Air-Cond., an audio video navigation AVN, a second DC/DC converter L/H-DC, a switch SW, and a controller (hereinafter, referred to as a “first controller”).

The first driving motor M may supply a driving force to the wheels of a vehicle and may be an AC motor for example.

The inverter IN may convert a direct current power supplied to the first driving motor M into alternating current.

The first high voltage battery MB may be fixed to and installed in the body of the first mobility apparatus MLT 1, for example, under the floor of the passenger compartment.

The main function of the first high voltage battery MB may be to supply electric power to the first driving motor M, and the first high voltage battery MB may be charged with the on-board charger OBC.

In addition, the first high voltage battery MB may be connected to the low voltage battery LB through the first DC/DC converter L-DC to charge the low voltage battery LB.

For charging the low voltage battery LB, the first DC/DC converter L-DC may be a low-voltage DC-DC converter (LDC).

The low voltage battery LB may be, for example, a 12 V or 24 V battery, and may supply electrical power to electrical devices in a vehicle, such as an air-conditioning device or an AVN, that operate at low voltage.

FIG. 1 shows a second high voltage battery SB installed in the second mobility apparatus MLT 2, but it is not necessarily limited thereto. For example, the second high voltage battery SB may be removably installed in the first mobility apparatus.

The second high voltage battery SB may be additionally connected to a vehicle power system including the first high voltage battery MB. That is, the second high voltage battery SB may be detachably and electrically connected to the power system by wire or wirelessly, if possible, so that the operation of the power system, i.e. power supply to vehicle electronics, driving motors, etc., may not be affected even when the second high voltage battery SB is not present.

In addition, the second high voltage battery SB may be called a replaceable battery, an auxiliary battery, an extended battery, or a secondary battery, but it is only to distinguish it from the first high voltage battery MB. In other words, nothing about the second high voltage battery SB, that is, nothing of the function, the features, the mechanical/electrical/chemical structure resulting from its relationship with other objects (including the first high voltage battery MB, a host vehicle, etc.) or its own mechanical/electrical/chemical structure, the type of battery (including packaging-type batteries, batteries with anode/cathode/separator materials, etc.), the charging method, etc., is limited by its name.

The second high voltage battery SB may be connected in communication with a first controller Ctrl 1 of the first mobility apparatus MLT 1 or a battery management system (BMS) of the first high voltage battery MB, which will be described below, by wire or wirelessly, so that various kinds of sensed information (e.g., voltage, current, temperature, etc.) related to the state of charge (SoC) and the physical/electrical/chemical state of the second high voltage battery SB, etc. may be transmitted to the first controller Ctrl 1. However, it is not necessarily limited thereto, and the information related to the second high voltage battery SB may be transmitted to the first controller Ctrl 1 through a second controller Ctrl 2 of the second mobility apparatus MLT 2, which will be described below.

According to this implementation, the high voltage battery applied to the first high voltage battery MB and the second high voltage battery SB may include a plurality of battery cells that output a unit voltage in a range of 2.7 V to 4.2 V, and a set number of battery cells may be connected in series/parallel to each other to form one module. The high voltage battery may have one or more battery modules connected in series/parallel to each other and packaged into one battery package to output a desired voltage of about 400 V, 800 V, several kV, etc.

The high voltage batteries of the first high voltage battery MB and the second high voltage battery SB may include the battery management system (BMS).

The BMS may include a battery management unit (BMU), a cell monitoring unit (CMU), and a battery junction box (BJB).

The BMS may perform a cell balancing function to ensure the performance of the entire battery pack by maintaining the voltage of each cell constant, a SoC function to calculate the capacity of the entire battery system, battery cooling, battery charging, battery discharge control, etc.

The BMU may receive information on all cells from the CMU and perform the functions of the BMS based thereon.

For example, the BMU may include two micro control units (MCUs), and each MCU may have one CAN communication port. A CAN interface may be included for the communication with a vehicle controller, which can be said to be the upper-level device of the BMS, and a CAN interface for collecting the information from the lower-level device thereof, the CMU, may be included.

The CMU may be directly attached to a battery cell to monitor voltage, current, temperature, etc. The CMU may not perform calculations related to the BMS algorithm and may only serve to monitor. A plurality of battery cells may be connected to one CMU, and information on each cell may be transmitted to the BMU through a CAN interface.

The BJB may be the pack-level sensing mechanism of the BMS and the connection between a high voltage battery and a drivetrain. The BJB may measure and record a battery's voltage and the current flowing in and out of the battery to accurately calculate the SoC. The BJB may also perform important functions for safety, such as monitoring of insulation as well as sensing of overcurrent.

The second high voltage battery SB may be a high voltage battery with a lower voltage than the first high voltage battery MB, and, in this case, the second DC/DC converter L/H-DC may be a step-up DC/DC converter. On the contrary, the second high voltage battery SB may be a high voltage battery with a higher voltage than the first high voltage battery MB, and, in this case, the second DC/DC converter L/H-DC may be a step-down DC/DC converter.

According to this implementation, the second DC/DC converter L/H-DC may be built into the first mobility apparatus MLT 1 in the power system, but is not limited thereto. For example, unlike this implementation, the second DC/DC converter L/H-DC may be provided as a separate component and may be additionally and detachably connected to the power system.

According to this implementation, in order to enable the second high voltage battery SB to be detachably and electrically connected to the power system, the power system of the first mobility apparatus MLT 1 may include a first connector C1, and the second high voltage battery SB may include a second connector C2. The first connector C1 may be connected to the second DC/DC converter L/H-DC as shown in the drawing.

In some examples, a signal transmission connector may be added to transmit various sensing and state information from the second high voltage battery SB to the controller.

In addition to supplying power to the first high voltage battery MB, the second DC/DC converter L/H-DC may be electrically connected to the inverter IN so that power may be supplied directly from the second high voltage battery SB to the inverter IN.

According to the control of the first controller Ctrl 1 and/or the second controller Ctrl 2, the power of the second high voltage battery SB may be used to charge the first high voltage battery MB and may be directly used as a power source for the first driving motor M.

According to this implementation, the first controller Ctrl 1 may be the uppermost vehicle controller that controls all electric devices of the first mobility apparatus MLT 1, but is not necessarily limited thereto. That is, for example, the first controller Ctrl 1 in FIG. 1 may be a power controller subordinate to a vehicle controller.

In addition, as described above, the first controller Ctrl 1 according to this implementation may include computer-readable recording media that store operating systems, logic instructions, input/output information, etc. and one or more processors that read them and perform the operation of making determinations and decisions, doing calculations, etc. to control the functions.

The second high voltage battery SB shown in FIG. 1 may be installed in the second mobility apparatus MLT 2 as shown in FIG. 2.

The second mobility apparatus MLT 2 may include a frame FRM, a second left wheel LW installed on the left side of the frame FRM, a second right wheel RW installed on the right side of the frame FRM, a second left driving motor LM that supplies a driving force to the second left wheel LW, a second right driving motor RM that supplies a driving force to the second right wheel RW, and the second controller Ctrl 2.

The second high voltage battery SB may be fixed to and installed in the second mobility apparatus MLT 2, but is not necessarily limited thereto. That is, the second high voltage battery SB may be removably installed in the second mobility apparatus MLT 2. As a result, it may be possible to replace the second high voltage battery SB mounted on the frame FRM with the SoC of being fully discharged with a new second high voltage battery SB with the SoC of being fully charged.

When the second high voltage battery SB is fixed to and installed in the second mobility apparatus MLT 2, the second mobility apparatus MLT 2 may include a charging connector for charging the second high voltage battery SB.

The frame FRM may form the exterior of the second mobility apparatus MLT 2 and may serve to accommodate other components.

The frame FRM may include a second pivot mechanism PM2 as a second connection mechanism, and the second pivot mechanism PM2 may be detachably and pivotably connected to a first pivot mechanism PM1, which is a first connection mechanism fixed to the body of the first mobility apparatus MLT 1.

For example, the first pivot mechanism PM1 may include an extension rod ER extending rearwardly from the body of the first mobility apparatus MLT 1 and a pivot pin PN protruding upward from an end of the extension rod ER.

In addition, the second pivot mechanism PM2 may include a triangular-shaped extension portion EP protruding forward from the frame FRM of the second mobility apparatus MLT 2 and a pivot ring PR into which the pivot pin PN may be rotatably inserted at the end of the extension portion EP.

When the pivot pin PN is inserted into the pivot ring PR, the linear movement of the pivot pin PN may be limited, and it may only rotate in the Z-axis direction in FIG. 2. Therefore, when the second mobility apparatus MLT 2 is pivotably connected, the linear movement of the second mobility apparatus MLT 2 may be limited about the pivot connection point with respect to the first mobility apparatus MLT 1, and the second mobility apparatus MLT 2 may only rotate about the Z axis.

When driving in the forward direction, that is, in the X-axis direction, the first mobility apparatus MLT 1 and the second mobility apparatus MLT 2 may remain in a straight line even without separate control of the steering of the second mobility apparatus MLT 2.

According to this implementation, the pivot mechanisms as the first and second connection mechanisms may be included, but it is not necessarily limited thereto. For example, the first and second connection mechanisms may be well-known mechanisms that enable non-rotational connection about the Z axis.

The rotation axis of the second left driving motor LM may be connected to the second left wheel LW so that the second left driving motor LM may supply a driving force to the second left wheel LW.

In addition, the rotation axis of the second right driving motor RM may be connected to the second right wheel RW so that the second right driving motor RM may supply a driving force to the second right wheel RW.

Because the second left wheel LW and the second right wheel RW may respectively be connected to the second left driving motor LM and the second right driving motor RM, it may be possible to drive them independently of each other.

It may be possible to drive the second left driving motor LM and the second right driving motor RM in the forward and reverse directions. When they are driven in the forward direction, the second mobility apparatus MLT 2 may travel forward, and, when they are driven in the reverse direction, it may travel backwards.

For example, the second left driving motor LM and the second right driving motor RM may each be designed as an in-wheel driving system where a driving motor is installed within a wheel, but they are not necessarily limited thereto.

In addition, unlike this implementation, the second mobility apparatus MLT 2 may be driven in the matter that the left and right sides of the second mobility apparatus MLT 2 are not independent of each other and the power of one common motor is divided and transmitted to the second left wheel LW and the second right wheel RW. To this end, a differential gear may be disposed between a common second driving motor and the second left wheel LW and the second right wheel RW. That is, the power of the common second driving motor may be distributed to the second left wheel LW and the second right wheel RW by the differential gear. In this case, a torque vectoring device may be added to distribute torque among the second left wheel LW and the second right wheel RW.

Referring to FIG. 2, the second controller Ctrl 2 may control the second left driving motor LM and the second right driving motor RM to allow the second mobility apparatus MLT 2 to travel forward and backward. In addition, when the steering of the second mobility apparatus MLT 2 is required, the second controller Ctrl 2 may control the torque or the number of rotations of each of the second left driving motor LM and the second right driving motor RM to change the direction in which the second mobility apparatus MLT 2 travels. That is, the driving of the second left driving motor LM and the second right driving motor RM may be separately controlled, so that it may be possible to achieve the steering of the second mobility apparatus MLT 2 without a separate steering device.

In addition, as described above, a wired or wireless communication device for transmitting information between the connectors in FIG. 1 and the first and second mobilities MLT 1 and MLT 2 may be included.

In some examples, according to this implementation, the first controller Ctrl 1 or the second controller Ctrl 2 may include a memory and a processor. Computer instructions for performing the functions of a corresponding controller may be stored in the memory, and the processor may perform the above-mentioned functions by loading the instructions from the memory and executing them.

For example, the memory may include at least one of a hard disk drive (HDD), a solid-state drive (SSD), a silicon disk drive (SDD), a ROM, a RAM, a CD-ROM, a magnetic tape, a floppy disk, and an optical data storage device.

In addition, for example, the processor may include at least one of a computer, a microprocessor, a central processing unit (CPU), an ASIC, an electric circuit, and a logic circuit.

The first connector C1 of the first mobility apparatus MLT 1 and the second connector C2 of the second mobility apparatus MLT 2 may be connected to each other, and the signal transmission connector may be connected, so that it may be possible that the first mobility apparatus MLT 1 and the second mobility apparatus MLT 2, that is, the first controller Ctrl 1 and the second controller Ctrl 2, communicate with each other.

When the first mobility apparatus MLT 1 starts to drive forward with the first mobility apparatus MLT 1 and the second mobility apparatus MLT 2 mechanically and electrically connected to each other, according to the driving speed or the signal transmitted from the first connector C1, the second controller Ctrl 2 may control the second left driving motor LM and the second right driving motor RM to enable the second mobility apparatus MLT 2 to drive straight ahead.

In that case, some or all of the speed, the position of the gear, the steering angle, the information on an accelerator pedal sensor (APS), and the information on a brake pedal sensor (BPS) of the first mobility apparatus MLT 1 may be transmitted to the second mobility apparatus MLT 2.

For example, the second controller Ctrl 2 of the second mobility apparatus MLT 2 may determine whether the first mobility apparatus MLT 1 is traveling forward or backward, based on some or all of the speed, the position of the gear, the information on an accelerator pedal sensor (APS), and the information on a brake pedal sensor (BPS) of the first mobility apparatus MLT 1. However, the present disclosure is not limited thereto, and it goes without saying that the second controller Ctrl 2 of the second mobility apparatus MLT 2 may receive the information on whether the first mobility apparatus MLT 1 is traveling forward or backward directly from the first controller Ctrl 1.

When the first mobility apparatus MLT 1 is traveling forward, the second controller Ctrl 2 may drive the second left driving motor LM and the second right driving motor RM in the forward direction to allow the second mobility apparatus MLT 2 to drive straight ahead. Furthermore, when the first mobility apparatus MLT 1 is traveling backward, the second controller Ctrl 2 may drive the second left driving motor LM and the second right driving motor RM in the reverse direction to allow the second mobility apparatus MLT 2 to drive backward.

In addition, the second controller Ctrl 2 may determine how the first mobility apparatus MLT 1 is being steered based on information on the steering angle of the first mobility apparatus MLT 1, and may steer the second mobility apparatus MLT 2 accordingly.

The second mobility apparatus MLT 2 may not include a separate steering device such as a steering wheel and a steering rack, and it may be possible to steer the second mobility apparatus MLT 2 by controlling the torque of the second left driving motor LM and the second right driving motor RM.

That is, the second controller Ctrl 2 may calculate a driving torque for driving and a steering torque for steering for each of the second left driving motor LM and the second right driving motor RM to perform the control operation.

For example, for the steering of the second mobility apparatus MLT 2, the steering torque values of the second left driving motor LM and the second right driving motor RM according to the steering angle of the first mobility apparatus MLT 1 may be included in a lookup table or a calculation program.

When the second mobility apparatus MLT 2 drives straight ahead, the speed of the second mobility apparatus MLT 2 may be controlled to be no greater than that of the first mobility apparatus MLT 1. As a result, the pivot connection between the first mobility apparatus MLT 1 and the second mobility apparatus MLT 2 may be maintained at a pivot angle within a predetermined range. For example, when the speed of the second mobility apparatus MLT 2 driving straight ahead is controlled to be no greater than that of the first mobility apparatus MLT 1, at the pivot connection point, the pivot angle between the second mobility apparatus MLT 2 and the first mobility apparatus MLT 1 may be maintained at 0 degree, i.e., the angle where the first mobility apparatus MLT 1 and the second mobility apparatus MLT 2 are in a straight line.

When the second mobility apparatus MLT 2 is driving forward, it may be controlled to follow the first mobility apparatus MLT 1, so that the driving of multiple mobilities connected to each other may be smoothly performed.

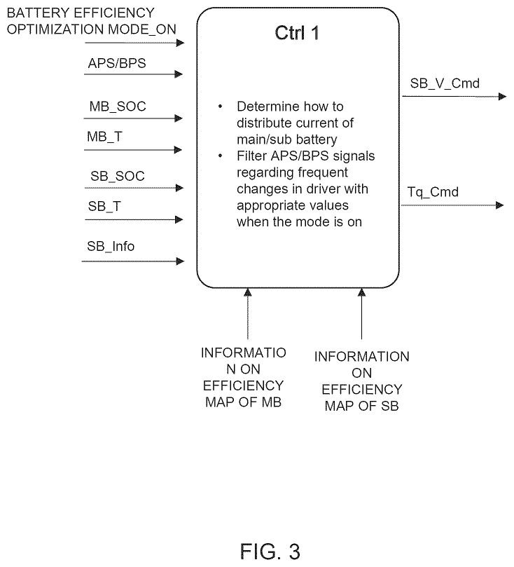

Hereinafter, a control process will be described with reference to FIGS. 3 to 6.

FIG. 3 shows an example of input/output information of the first controller Ctrl 1.

As shown in FIG. 3, the first controller Ctrl 1 may receive input information including information on whether a battery efficiency optimization mode has been selected, information on APS/BPS, the SOC (MB_SOC) of the first high voltage battery MB, the temperature (MB_T) of the first high voltage battery MB, the SOC (SB_SOC) of the second high voltage battery SB, the temperature (SB_T) of the second high voltage battery SB, information (SB_Info) on the second high voltage battery SB, the efficiency map of the first high voltage battery MB (hereinafter, referred to as a “first efficiency map”), the efficiency map of the second high voltage battery SB (hereinafter, referred to as a “second efficiency map”), etc., and may output the voltage command (SB_V_Cmd) of the second high voltage battery SB, the torque command (Tq_Cmd) of the first driving motor M, etc.

The first controller Ctrl 1 may receive information on whether the battery efficiency optimization mode has been selected through a user interface. For example, a user interface may be provided as an AVN screen, through which a driver selects the battery efficiency optimization mode.

The information on APS/BPS may be received from an accelerator pedal sensor and a brake pedal sensor.

In addition, the information on the SOC (MB_SOC) and the temperature (MB_T) of the first high voltage battery MB and the information on the SOC (SB_SOC) and the temperature (SB_T) of the second high voltage battery SB may respectively be received from the BMSs of the first high voltage battery MB and the second high voltage battery SB. As described above, the information on the SOC (SB_SOC) and the temperature (SB_T) of the second high voltage battery SB may also be received from the second controller Ctrl 2.

It may be possible to download and store the information (SB_Info) on the second high voltage battery SB by type of high voltage battery from an external server, and the information (SB_Info) on the second high voltage battery SB may include the type, the manufacturer, the model number, the efficiency map data for the SOC, the temperature, and the current, etc. of the high voltage battery. The first controller Ctrl 1 may request information on an efficiency map of a high voltage battery from an external server through a communication device, and may receive the information therefrom as needed, that is, at S20, which will be described below.

The first efficiency map of the first high voltage battery MB and the second efficiency map of the second high voltage battery SB may be stored in the memory.

Here, the second efficiency map may be stored for each type of the second high voltage battery SB.

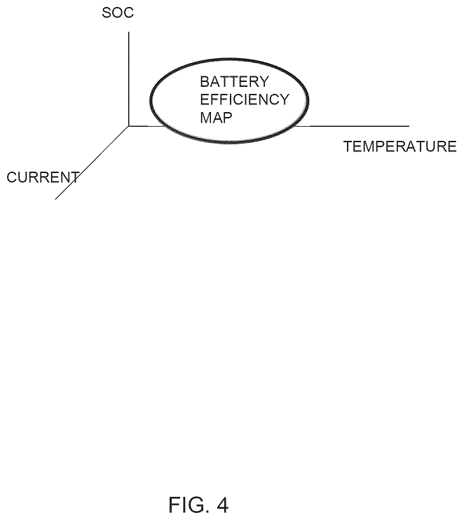

The second high voltage battery SB that can be connected to the first mobility apparatus MLT 1 may be divided into several types, and the efficiency map may be different for each type. Here, as shown in FIG. 4, the efficiency map may be data on efficiency values according to SOC, temperature, and current, and, when SOC, temperature, and current are determined, a corresponding efficiency value may be determined. Here, the efficiency map data may be in the form of a lookup table or a formula.

Accordingly, the first controller Ctrl 1 may determine the type of the second high voltage battery SB that is currently connected, based on information on the second high voltage battery SB, and may select the second efficiency map corresponding to the type.

In addition, when the first mobility apparatus MLT 1 has yet to have information on the efficiency map of a new type of second high voltage battery SB, the first controller Ctrl 1 may request the data from an external server, download it, and store it in a memory.

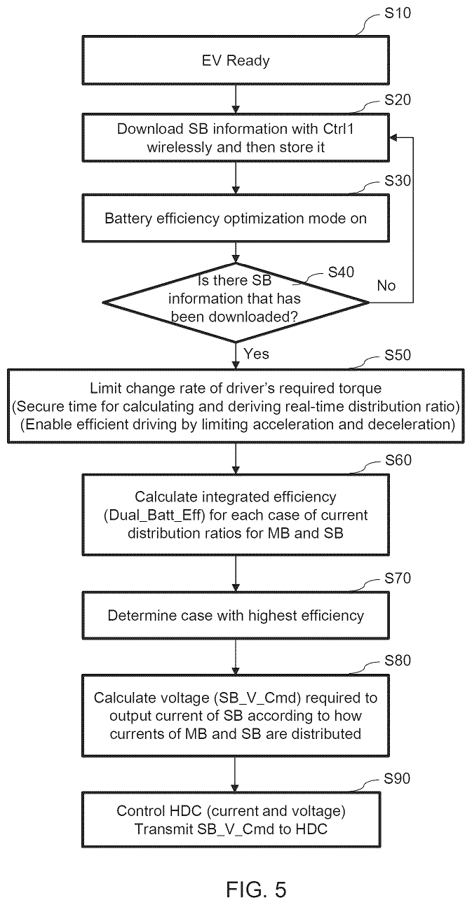

Hereinafter, the entire control process will be described in detail with reference to FIG. 5.

At S10, the first mobility apparatus MLT 1 may be in a drivable state. In other words, the first mobility apparatus MLT 1 may be in an “EV Ready” state, and it may be possible for a driver to drive the first mobility apparatus MLT 1 at any time when the driver presses the accelerator pedal because current is supplied to the first driving motor M.

As described above, at S20, the first controller Ctrl 1 may receive information on the second high voltage battery SB from an external server using a communication device.

When a driver has selected the battery efficiency optimization mode through a user interface, the first controller Ctrl 1 may receive information on the result through the user interface and determine that the mode is on at S30.

At S40, the first controller Ctrl 1 may check whether information on the second high voltage battery SB that is currently connected has been stored in the memory. That is, it may check whether the efficiency map corresponding to the type of the second high voltage battery SB that is currently connected has been stored in the memory.

Here, when it is determined that there is no efficiency map of the corresponding type in the memory, the first controller Ctrl 1 may download and store the efficiency map of the corresponding type as in S20.

Next, the first controller Ctrl 1 may limit the change rate of a driver's required torque at S50. This may be to secure the time necessary for calculation of current distribution, which will be described below. To this end, the slope of an APS signal resulting from a driver pressing an accelerator pedal may be limited. For example, even when an APS signal with a steep slope is received, it may be gently adjusted and limited.

At S60, the first controller Ctrl 1 may determine a driver's required torque determined based on an APS signal, and may determine an integrated efficiency for each case of a current distribution ratio of the first high voltage battery MB and the second high voltage battery SB based on the driver's required torque.

To this end, the first controller Ctrl 1 may determine a distributed current of each of the first high voltage battery MB and the second high voltage battery SB for each of a plurality of cases for which distribution ratios have been predetermined, may determine a first efficiency value for the first high voltage battery MB and a second efficiency value for the second high voltage battery SB for each of the cases, and may determine one of the plurality of cases based on the first efficiency value and the second efficiency value for each of the cases.

Here, in order to determine one of the plurality of cases, an integrated efficiency value may be determined based on first and second efficiency values for each of the cases, and, among the plurality of cases, the case with the greatest integrated efficiency value may be determined.

In addition, an integrated efficiency value may be determined based on the multiplication of a first efficiency value, a second efficiency value, and a gain.

Here, the gain may be determined based on the state of health (SoH) of the first high voltage battery MB, the capacity of the first high voltage battery MB, the capacity of the second high voltage battery SB, the path efficiency between the first driving motor M and the second high voltage battery SB, and the efficiency of a DC/DC converter, which can be obtained through a test, for example.

Furthermore, the first efficiency value may be determined according to the first efficiency map for the SoC, the temperature, and the current of the first high voltage battery MB, and the second efficiency value may be determined according to the second efficiency map for the SoC, the temperature, and the current of the second high voltage battery SB.

An integrated efficiency value may be determined for each of the cases, and, at S70, the first controller Ctrl 1 may determine the case with the greatest integrated efficiency value, and may determine the distributed current of the first high voltage battery MB and the distributed current of the second high voltage battery SB accordingly.

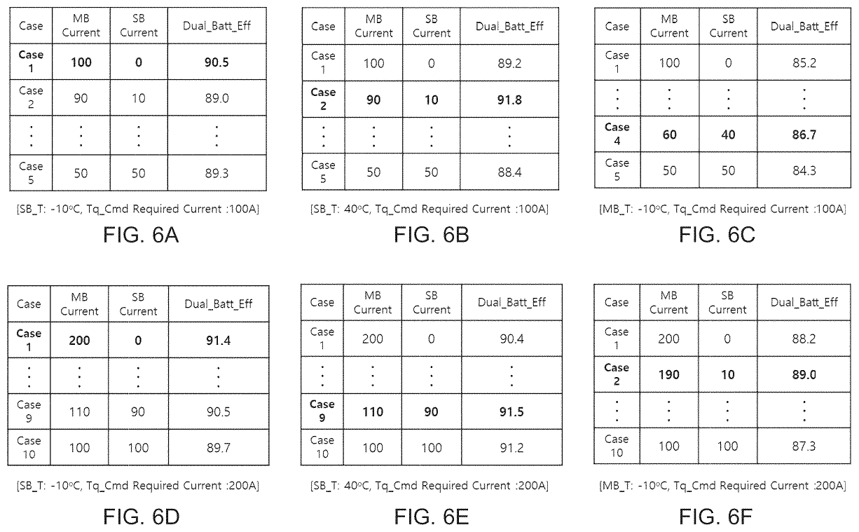

FIGS. 6A-6F show how an integrated efficiency value for each of the cases is determined for each required current according to the temperature of the second high voltage battery SB and a driver's required torque.

In FIG. 6A, the temperature of the second high voltage battery SB is −10 degrees, and the required current is 100 A. In Case 1, the distributed current of the first high voltage battery MB is 100 A, and the distributed current of the second high voltage battery SB is 0; in Case 2, the distributed current of the first high voltage battery MB is 90 A, and the distributed current of the second high voltage battery SB is 10; and, in Case 5, the distributed current of the first high voltage battery MB is 50 A, and the distributed current of the second high voltage battery SB is 50.

For Case 1 in FIG. 6A, it may be possible to obtain the first efficiency value from the first efficiency map by adding information on the temperature and the SOC of the first high voltage battery MB to the distributed current of the first high voltage battery MB of 100 A. In addition, it may be possible to obtain the second efficiency value from the second efficiency map by adding information on the temperature and the SOC of the second high voltage battery SB to the distributed current of the second high voltage battery SB of 0 A. In addition, it may be possible to calculate and obtain the integrated efficiency value (Dual_Batt_Eff) from the first efficiency value and the second efficiency value.

FIG. 6A shows that the integrated efficiency values (Dual_Batt_Eff) are 90.5, 89.0, and 89.3 in Cases 1, 2, and 5, respectively.

In FIG. 6A, the case with the highest efficiency is Case 1, so the distributed currents of the first high voltage battery MB and the second high voltage battery SB are finally determined to be 100 A and 0 A, respectively.

In FIG. 6B, the temperature of the second high voltage battery SB is 40 degrees, and the required current is 100 A. In this case, the case with the highest efficiency is Case 2 where the integrated efficiency value (Dual_Batt_Eff) is 91.8, so the distributed currents of the first high voltage battery MB and the second high voltage battery SB are finally determined to be 90 A and 10 A, respectively.

In FIG. 6C, the temperature of the first high voltage battery MB is −10 degrees, and the required current is 100 A. In this case, the case with the highest efficiency is Case 4 where the integrated efficiency value (Dual_Batt_Eff) is 86.7, so the distributed currents of the first high voltage battery MB and the second high voltage battery SB are finally determined to be 60 A and 40 A, respectively.

In FIG. 6D, the temperature of the second high voltage battery SB is −10 degrees, and the required current is 200 A. In this case, the case with the highest efficiency is Case 1 where the integrated efficiency value (Dual_Batt_Eff) is 91.4, so the distributed currents of the first high voltage battery MB and the second high voltage battery SB are finally determined to be 200 A and 0 A, respectively.

In FIG. 6E, the temperature of the second high voltage battery SB is 40 degrees, and the required current is 200 A. In this case, the case with the highest efficiency is Case 9 where the integrated efficiency value (Dual_Batt_Eff) is 91.5, so the distributed currents of the first high voltage battery MB and the second high voltage battery SB are finally determined to be 110 A and 90 A, respectively.

In FIG. 6F, the temperature of the first high voltage battery MB is 40 degrees, and the required current is 200 A. In this case, the case with the highest efficiency is Case 2 where the integrated efficiency value (Dual_Batt_Eff) is 89.0, so the distributed currents of the first high voltage battery MB and the second high voltage battery SB are finally determined to be 190 A and 10 A, respectively.

When how to distribute current has been determined, at S80, the first controller Ctrl 1 may determine the voltage required to output the distributed current of the second high voltage battery SB and may output a command (SB_V_Cmd) for that voltage.

The distributed current of the second high voltage battery SB and the voltage determined accordingly may be transmitted to the second DC/DC converter, and the second DC/DC converter may output accordingly at S90.

In addition, the output current of the first high voltage battery MB and the output current of the second DC/DC converter may be supplied to the inverter and transmitted to the first driving motor M.

The foregoing descriptions of the specific exemplary implementations of the present disclosure have been presented for the purposes of illustration and description. They are not intended to be exhaustive or to limit the present disclosure to the precise forms disclosed, and obviously many modifications and variations are possible in light of the above-described teachings. The exemplary implementations were chosen and described to explain certain principles of the present disclosure and their practical application, to enable others skilled in the art to make and utilize the various exemplary implementations of the present disclosure, as well as various alternatives and modifications thereof. It is intended that the scope of the present disclosure be defined by the claims appended hereto and their equivalents.

What is claimed is:

1. A mobility apparatus comprising
a plurality of first wheels;
at least one first driving motor configured to supply driving force to the plurality of first wheels;
a first high voltage battery configured to supply power to the at least one first driving motor; and
a controller configured to control the at least one first driving motor and the first high voltage battery,
wherein the controller is further configured to, based on a second high voltage battery being detachably connected to the mobility apparatus to supply power to the at least one first driving motor, (i) determine a drive torque for the mobility apparatus and (ii) determine distributed currents of the first high voltage battery and the second high voltage battery based on (i) the drive torque and (ii) efficiency-related states of the first high voltage battery and the second high voltage battery.

2. The mobility apparatus of claim 1, wherein the controller is further configured to:
determine the distributed current of each of the first high voltage battery and the second high voltage battery for each of a plurality of cases, the plurality of cases including a plurality of predetermined current distribution ratios between the first high voltage battery and the second high voltage battery;
determine a first efficiency value for the first high voltage battery and a second efficiency value for the second high voltage battery for each of the plurality of cases; and
determine one of the plurality of cases based on the first efficiency value and the second efficiency value for each of the plurality of cases.

3. The mobility apparatus of claim 2, wherein the controller is further configured to:
determine an integrated efficiency value based on the first efficiency value and the second efficiency value for each of the plurality of cases; and
determine the one of the plurality of cases having a greatest value in the integrated efficiency values of the plurality of cases.

4. The mobility apparatus of claim 3, wherein the controller is configured to determine the integrated efficiency value for each of the plurality of cases based on a multiplication value of the first efficiency value, the second efficiency value, and a gain.

5. The mobility apparatus of claim 4, wherein the second high voltage battery is detachably connected to the at least one first driving motor through a direct current/direct current (DC/DC) converter, and
wherein the gain is determined based on (i) a state of health (SoH) of the first high voltage battery, (ii) a capacity of the first high voltage battery, (iii) a capacity of the second high voltage battery, (iv) a path efficiency between the first driving motor and the second high voltage battery, and (v) an efficiency of the DC/DC converter.

6. The mobility apparatus of claim 2, wherein the first efficiency value is determined according to a first efficiency map for a state of charge (SoC) of the first high voltage battery, a temperature of the first high voltage battery, and electric current of the first high voltage battery, and
wherein the second efficiency value is determined according to a second efficiency map for an SoC of the second high voltage battery, a temperature of the second high voltage battery, and electric current of the second high voltage battery.

7. The mobility apparatus of claim 6, further comprising a memory configured to store one or more efficiency maps corresponding to one or more high voltage batteries,
wherein the controller is configured to select an efficiency map from the one or more efficiency maps corresponding to the second high voltage battery.

8. The mobility apparatus of claim 7, wherein the controller is configured to, based on determining that the one or more efficiency maps do not include the second efficiency map corresponding to the second high voltage battery, request download of the second efficiency map to an external server.

9. The mobility apparatus of claim 1, wherein the controller is further configured to determine a battery efficiency optimization mode selected by a driver of the mobility apparatus.

10. The mobility apparatus of claim 1, wherein the second high voltage battery is detachably connected to the at least one first driving motor through a DC/DC converter, and
wherein the controller is further configured to transmit a control command to the DC/DC converter based on the distributed current of the second high voltage battery.

11. The mobility apparatus of claim 1, wherein the controller is further configured to limit a rate of change of the drive torque.

12. A method of controlling driving current for a mobility apparatus, the mobility apparatus including a plurality of first wheels, at least one first driving motor configured to supply a driving force to the plurality of first wheels, a first high voltage battery configured to supply power to the at least one first driving motor, and a controller configured to control the at least one first driving motor and the first high voltage battery, the method comprising:
determining a drive torque based on a second high voltage battery being detachably connected to the mobility apparatus to supply power to the at least one first driving motor; and
determining distributed currents of the first high voltage battery and the second high voltage battery based on (i) the drive torque and (ii) efficiency-related states of the first high voltage battery and the second high voltage battery.

13. The method of claim 12, wherein determining the distributed currents comprises:
determining the distributed current of each of the first high voltage battery and the second high voltage battery for each of a plurality of cases, the plurality of cases including a plurality of predetermined current distribution ratios between the first high voltage battery and the second high voltage battery;
determining a first efficiency value for the first high voltage battery and a second efficiency value for the second high voltage battery for each of the plurality of cases, and
determining one of the plurality of cases based on the first efficiency value and the second efficiency value for each of the plurality of cases.

14. The method of claim 13, wherein determining the one of the plurality of cases comprises:
determining an integrated efficiency value based on the first efficiency value and the second efficiency value for each of the plurality of cases; and
determining the one of the plurality of cases having a greatest value in the integrated efficiency values of the plurality of cases.

15. The method of claim 14, wherein the integrated efficiency value is determined based on a multiplication value of the first efficiency value, the second efficiency value, and a gain.

16. The method of claim 15, wherein the second high voltage battery is detachably connected to the at least one first driving motor through a DC/DC converter, and
wherein the gain is determined based on a state of health (SoH) of the first high voltage battery, a capacity of the first high voltage battery, a capacity of the second high voltage battery, a path efficiency between the first driving motor and the second high voltage battery, and an efficiency of the DC/DC converter.

17. The method of claim 13, wherein the first efficiency value is determined according to a first efficiency map for a state of charge (SoC) of the first high voltage battery, a temperature of the first high voltage battery, and electric current of the first high voltage battery, and
wherein the second efficiency value is determined according to a second efficiency map for an SoC of the second high voltage battery, a temperature of the second high voltage battery, and electric current of the second high voltage battery.

18. The method of claim 17, wherein the mobility apparatus further includes a memory configured to store one or more efficiency maps corresponding to one or more high voltage batteries, and
wherein the method further comprises selecting an efficiency map from the one or more efficiency maps corresponding to the second high voltage battery.

19. The method of claim 18, further comprising requesting, by the controller, download of the second efficiency map to an external server based on determining that the one or more efficiency maps do not include the second efficiency map corresponding to the second high voltage battery.

20. The method of claim 12, further comprising determining a battery efficiency optimization mode selected by a driver of the mobility apparatus.
